(19) United States
(12) Patent Application Publication
(10) Pub. No.: US 2013/0001328 A1
(43) Pub. Date: Jan. 3, 2013

(54) Single piece atomizing nozzle with leakage-stopping assembly

(76) Inventor: Hui San Hsu, Taichung City (TW)

(21) Appl. No.: 13/135,296

(22) Filed: Jun. 30, 2011

(51) Int. Cl. B05B 1/00

(52) U.S. Cl. 239/589

(57) ABSTRACT

A single piece atomizing nozzle has a body having one end formed with an inlet and the other end formed with a ring, which has an outlet. A passage is formed in an axial direction of the body, and has two ends respectively connected to the inlet and the outlet. A rotor is rotatably disposed in the passage, and a leakage-stopping assembly is disposed in the passage and between the rotor and the inlet. Also, a stopping mechanism is formed or disposed at the inlet to prevent the leakage-stopping assembly from escaping from the inlet. Alternatively, a water output block is disposed on the ring to prevent the leakage-stopping assembly from escaping from the ring. Thus, the effects of the simple structure, the small size and the lighted weight can be obtained.

### BACKGROUND OF THE INVENTION

1. Field of the Invention

The invention relates to the technological field of an atomizing device, and more particularly to a single piece atomizing nozzle capable of atomizing and ejecting water or liquid.

2. Related Art

A typical atomizing system or device may have an atomizing nozzle disposed at an outlet. When the water or liquid flows through the atomizing nozzle, a rotor disposed in a body of the atomizing nozzle and a water jetting hole of a cover of the atomizing nozzle can be utilized to atomize and eject the water or liquid.

U.S. Pat. No. 5,921,468 discloses a single piece atomizing nozzle, which is mainly composed of a body and a rotor. A passage is formed inside the body in the axial direction, and the rotor is movably disposed in the passage.

When the atomizing nozzle of the '468 patent does not work, the rotor can be moved close to the water inlet end or the water outlet end according to the assembling direction of the atomizing nozzle and the weight thereof. However, no proper leakage-stopping design is provided, so the water or liquid tends to leak or drip down.

In order to prevent the water or liquid from dripping and leaking when the atomizing nozzle does not work, a leakage-stopping assembly may be disposed inside the atomizing nozzle in the axial direction. The typical design is to place the leakage-stopping assembly within an auxiliary body, and then the auxiliary body is combined with the original body.

Thus, the leakage-stopping assembly cannot be added without the auxiliary body. So, the size and the weight of the atomizing nozzle, as well as the required package size are increased.

### SUMMARY OF THE INVENTION

It is therefore an object of the invention to provide a single piece atomizing nozzle having a leakage-stopping assembly and the effects of the simple structure and the small size.

According to the above-mentioned object and effects, the invention provides a single piece atomizing nozzle having a body, a passage, a rotor and a leakage-stopping assembly. The body has one end formed with an inlet and the other end formed with a ring, which has an outlet. The passage is formed inside the body in an axial direction and has two ends respectively connected to the inlet and the outlet. The rotor is rotatably disposed in the passage. The leakage-stopping assembly is disposed in the passage and between the rotor and the inlet.

Also, a stopping mechanism is formed or disposed at the inlet of this invention to prevent the leakage-stopping assembly from the inlet. Alternatively, a water output block is disposed on the ring to restrict the leakage-stopping assembly from escaping from the ring.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is a schematic illustration showing a structure according to a first embodiment of the invention.

FIG. 2 is a schematic illustration showing a structure according to a second embodiment of the invention.

FIG. 3 is a schematic illustration showing a structure according to a third embodiment of the invention.

### DETAILED DESCRIPTION OF THE INVENTION

The present invention will be apparent from the following detailed description, which proceeds with reference to the accompanying drawings, wherein the same references relate to the same elements.

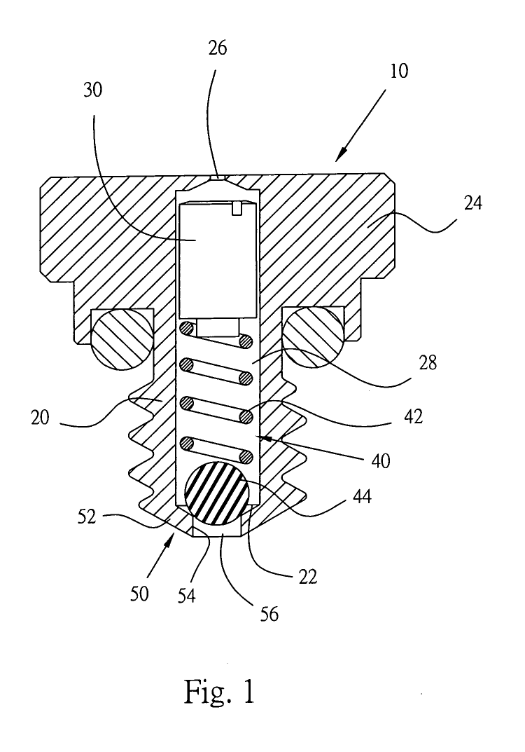

Referring to FIG. 1, an atomizing nozzle 10 of the invention assembled in a predetermined conduit (not shown) includes a body 20, a rotor 30 and a leakage-stopping assembly 40.

The body 20 has one axial end formed with an inlet 22, and the other axial end being an integrally formed ring 24 formed with an outlet 26. The body 20 has an axial passage 28 formed therein, and two ends of the passage 28 are communicated with the inlet 22 and the outlet 26, respectively.

The rotor 30 is rotatably disposed in the passage 28. The leakage-stopping assembly 40 is disposed in the passage 28 and between the rotor 30 and the inlet 22. The leakage-stopping assembly 40 is constituted by a spring 42 and a ball plunger 44 connected to the spring 42. The ball plunger 44 is disposed at one end of the spring 42 and corresponds to the inlet 22.

Because the atomizing nozzle 10 is one single piece, the rotor 30 and the leakage-stopping assembly 40 can be installed into the passage 28 from the inlet 22. In addition, a stopping mechanism 50 is further formed at the inlet 22 to prevent the rotor 30 and the leakage-stopping assembly 40 from escaping from the inlet 22. The stopping mechanism 50 may be a stopping lip 52 integrally formed at the end portion of the body 20, and the stopping lip 52 has a lip edge 54 directed to the center of the inlet 22. In addition, the stopping lip 52 has a through hole 56 communicating with the inlet 22 and the passage 28.

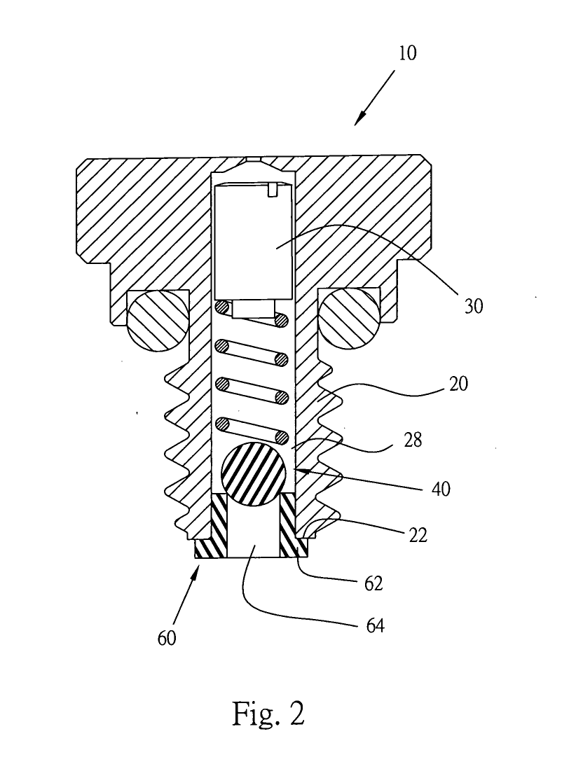

FIG. 2 is a schematic illustration showing a structure according to a second embodiment of the invention. As shown in FIG. 2, the single piece atomizing nozzle 10 provides another type of stopping mechanism 60. The stopping mechanism 60 is a stopping plunger 62, and is assembled at the inlet 22 of the body 20 by way of tight fitting. Next, the stopping plunger 62 has an axial through hole 64 communicating with the inlet 22 and the passage 28. Thus, the stopping plunger 62 can restrict the leakage-stopping assembly 40 and the rotor 30 from escaping from the passage 28, and the through hole 64 allows the water or liquid to enter the passage 28.

In FIGS. 1 and 2, the rotor 30 and the leakage-stopping assembly 40 enter the passage 28 from the inlet 22.

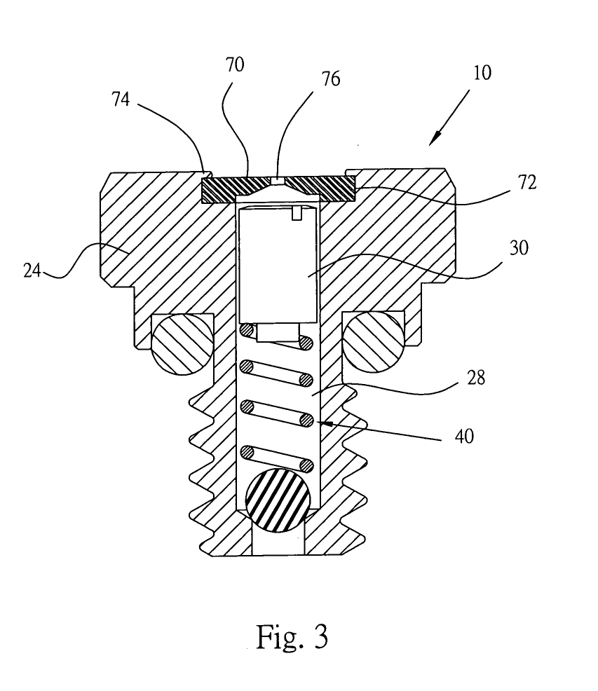

As shown in FIG. 3, the rotor 30 and the leakage-stopping assembly 40 of the single piece atomizing nozzle 10 in the third embodiment enter the passage 28 from the ring 24. More specifically, a receiving slot 72 communicating with the passage 28 is formed on the ring 24, so that the leakage-stopping assembly 40 and the rotor 30 can enter the passage 28 through the receiving slot 72.

Moreover, a water output block 70 is assembled in the receiving slot 72 and is formed with a suitable riveting flange 74 so that the water output block 70 can be positioned, and the rotor 30 and the leakage-stopping assembly 40 in the passage 28 cannot escape.

Next, the water output block 70 has an outlet 76 communicating with the passage 28. So, the water or liquid flowing through the passage 28 can be ejected from the outlet 76 of the water output block 70.

Each of the structural configurations of the embodiments pertains to the single piece atomizing nozzle 10, and is provided with the leakage-stopping assembly 40. So, the effects of the simple structure, the small size and the lighted weight can be obtained.

While the present invention has been described by way of examples and in terms of preferred embodiments, it is to be understood that the present invention is not limited thereto. To the contrary, it is intended to cover various modifications. Therefore, the scope of the appended claims should be accorded the broadest interpretation so as to encompass all such modifications.

What is claimed is:

1. A single piece atomizing nozzle, comprising:
a body having one axial end formed with an inlet;
a ring, having an outlet and being integrally formed at an axial end portion of the body;
a passage, which is formed in an axial direction of the body and has two ends respectively connected to the inlet and the outlet;
a rotor rotatably disposed in the passage; and
a leakage-stopping assembly disposed in the passage and between the rotor and the inlet.

2. The atomizing nozzle according to claim 1, further comprising a stopping mechanism, which is disposed at the inlet and prevents the leakage-stopping assembly from escaping from the passage.

3. The atomizing nozzle according to claim 2, wherein the stopping mechanism is a stopping lip, which is integrally formed on the end portion of the body and has a lip edge directing toward a center of the inlet.

4. The atomizing nozzle according to claim 2, wherein the stopping mechanism is a stopping plunger, which is tightly fit with the inlet, and has an axial through hole communicating with the passage.

5. The atomizing nozzle according to claim 1, wherein the ring has an output block, the output block is assembled on the ring and corresponds to the passage, and the outlet penetrates through the output block and is communicated with the passage.

6. The atomizing nozzle according to claim 1, wherein the leakage-stopping assembly has a spring and a ball plunger disposed at one end of the spring, and the ball plunger corresponds to the inlet.
